(19) United States
(12) Patent Application Publication
(10) Pub. No.: US 2011/0294564 A1
(43) Pub. Date: Dec. 1, 2011

(54) ANIMATION FOR A PRODUCTIVITY APPLICATIONS LEARNING TOOL GAME

(75) Inventors: Jennifer P. Michelstein, Kirkland, WA (US); Jonas Helin, Kirkland, WA (US); Abhishek Agrawal, Seattle, WA (US); Steve Courtney, Redmond, WA (US)

(73) Assignee: MICROSOFT CORPORATION, Redmond, WA (US)

(21) Appl. No.: 13/111,101

(22) Filed: May 19, 2011

Related U.S. Application Data
(63) Continuation-in-part of application No. 12/790,472, filed on May 28, 2010.

(51) Int. Cl. A63F 13/00

(52) U.S. Cl. 463/23

(57) ABSTRACT

Consolidated game flow for a plurality of different productivity applications is provided by a challenge director program module which may be local to a computing device or accessible via a remote network server at a challenge director interface of the productivity application currently utilized by a user. A consolidated game board display output of the challenge director at the computing device may encourage learning features of different productivity applications via attractive images that may be animated. Animation sequences may be provided at the challenge director interface which may grab the attention of a user of a productivity application to play a challenge or reward usage of learned productivity application features. Further animation sequences may be provided for entertainment during interactive game board play such as animation sequences played between skill levels of play or during play.

### CROSS REFERENCE TO RELATED APPLICATIONS

This application is a continuation-in-part of U.S. application Ser. No. 12/790,472 filed May 28, 2010, entitled “Using Game Play Elements to Motivate Learning,” of Jennifer Michelstein et al., incorporated by reference herein as to its entire contents and is related by subject matter to U.S. application Ser. No. ______, filed concurrently herewith of Jennifer Michelstein et al., entitled “Consolidated Game Flow for Learning Productivity Applications,” incorporated by reference herein as to its entire contents.

### BACKGROUND

Modern productivity applications enable users to perform a large number of commands, for example, during the preparation of documents or within data files. For example, a word processor productivity application can enable a user to manipulate the appearance of text, insert tables, insert footnotes, create tables of content, add page numbers, review changes, and so on. In another example, a spreadsheet application can enable a user to select styles for cells, create and insert charts, set the layout for spreadsheet pages, and so on. In yet another example, a presentation application may enable a user to combine tables, text, graphics and image data into an integrated presentation, and so on. In yet another example, a database application can enable a user to enter data into a database linked to other data, for example, in a database tree of a relational database, and so on.

Other productivity applications may be provided such as for note-taking, browsing the Web, preparing formal drawings, managing personal calendars and communications and the like. Moreover, many such productivity applications provide for consolidation and/or interworking, for example, such that text or graphics or data from one productivity application may be utilized in another different productivity application. For example, a text passage from a document prepared with a word processor application may be copied to a document prepared in one of a spreadsheet application, a presentation application or a drawing application.

Traditionally, productivity applications have used menu systems to enable users to select and perform commands on documents. A menu system comprises a set of menus. Each of the menus contains one or more menu items. Selection of a menu item can cause a productivity application to perform a command on a document, open an interface that provides the user with more options such as, for example, a “help” option, or perform some other action or provide an additional feature. Menu systems can be beneficial because menu systems frequently do not occupy large amounts of onscreen space. However, users may find it difficult to find commands because a desired menu item associated with those commands may be located in a long list of menu items.

In addition to menu systems, some productivity applications provide toolbars. A toolbar comprises a fixed set of selectable icons associated with commands. The icons can graphically suggest the effect of performing the commands associated with the icons. Selection of an icon can cause the productivity application to perform some command. Toolbars can be beneficial because the graphical icons can help users more quickly and easily understand the associated commands than menus. Furthermore, toolbars can be beneficial because toolbars can remain onscreen and thus can be selected with a single click. Labeling the icons with text can cause each icon to become so large that the toolbar occupies an unacceptable amount of onscreen space.

A ribbon-shaped user interface is known that may include a set of toolbars placed on tabs in a tab bar. The tab bar can be rectangular in shape and each tab labeled. Ribbon-shaped user interfaces can have the benefits of toolbars in that users can see and select graphical icons to perform commands. Furthermore, ribbon-shaped user interfaces can have some of the benefits of menu systems because not all of the icons are onscreen at once. As a result, a ribbon-shaped user interface can occupy less onscreen space on a given screen than a toolbar because only one tab is open for display at a time.

A computing device displays a user interface containing a ribbon-shaped user interface. The ribbon-shaped user interface may contain multiple tabs. Each of the tabs may contain multiple controls, features or commands. Furthermore, the computing device may display a challenge of a learning tool game and a tab visualization control in the user interface. The challenge of the learning tool game may offer a user the opportunity to learn a command or feature of an associated productivity application or instruct a user of the computing device to perform a task using one of a menu, a toolbar and a ribbon-shaped user interface of the productivity application. The challenge may not instruct the user how to perform the task. If the user does not know how to perform the task using the ribbon-shaped user interface, the user may select a tab visualization control. In response to receiving selection of the tab visualization control, the computing device may display a popup window in the user interface. The popup window may initially contain an image of an initial portion of a given tab in the ribbon-shaped user interface. The image of the given tab may scroll within the popup window such that a target control in the given tab is visible within the popup window. The user may need to use the target control to perform the task. Scrolling the image of the given tab within the popup window can help the user learn the location of the target control within the tab.

A known learning tool provides such a user interface through which a user may learn the use of commands of a productivity application, and, in so doing, obtain a score and compete against others in a social network, Michelstein et al., U.S. patent application Ser. No. 12/943,668 filed Nov. 10, 2010, entitled “Learning Tool for a Ribbon-Shaped User Interface,” describes such a learning tool user interface and is incorporated by reference as to its entire contents. The learning tool may be considered a game. Some individuals even play a game to a point where they vigorously compete against others. Typically, a user may be encouraged to play an electronic game because they expect to be presented with unique and entertaining animation, for example, as a reward between levels of game play. To become proficient at a learning tool game, a user may also learn a productivity application and be presented with entertaining animation as they learn the productivity application. The learning game tool animation may, for example, be associated with and integrally a part of each productivity application as well as play a part in the learning tool game itself.

Given the foregoing, what is needed are systems, methods and computer program products for providing animation by means of a consolidated game flow interface within a productivity application and through a consolidated game board for a learning tool game. Either a productivity application interface or a consolidated game board may provide entertaining animation. The productivity application may provide animation to encourage a user to access the consolidated game board. During game play, animation may be associated with imaginary worlds in which a user plays a game and between skill levels of game play as a reward.

### SUMMARY

This summary is provided to introduce a selection of concepts. These concepts are further described below in the Detailed Description. This summary is not intended to identify key features or essential features of the claimed subject matter, nor is this summary intended as an aid in determining the scope of the claimed subject matter.

A consolidated game flow for learning productivity applications facilitates not only learning a single productivity application, but also encourages a user to learn how a given productivity application may interwork with different productivity applications as well as features of other productivity applications from the same consolidated game board. That is, challenges of a game for learning one productivity application may encourage a user to learn another, different productivity application feature or may launch a different productivity application than a currently utilized productivity application in a ribbon-based or other form of productivity application environment. A user may access a consolidated game flow game board via a selected portion of a productivity application user interface representing a level of play of a learning tool game. For example, a challenge director interface may comprise a portion of a ribbon, toolbar or may comprise a drop-down menu item.

In one embodiment, the challenge director interface of the productivity application provides a visual indication of skill level of play and accumulated point score for all challenges played in the learning tool game. The challenge director interface provides a user interface to actuate a consolidated game board presented under control of a challenge director. A challenge director interface may comprise a stand-alone application as may the challenge director application. Each of the stand alone challenge director interface and one associated with a productivity application may be separately launched. An animation sequence may play in a portion of a productivity application display screen dedicated to the challenge director interface to cause attention to be placed on the challenge director interface. The animation sequence may, for example, comprise a rotating circle in color and the encouraging words “Play Now.” The animation sequence may be played, for example, when the user opens the productivity application, play periodically during use of the productivity application or at shut down by way of example. In another embodiment, animation sequences may reward a user for utilizing a skill learned during productivity application usage, for example, such as awarding some points when a command such as underlining is used during productivity application usage or when a milestone of, for example, fifty such usages of underlining is achieved.

Moreover, animation may be provided once an interactive consolidated game board is presented to the user and game play begins. For example, in order to move from level to level of learning tool game play, one may be required to earn a sufficient score in each of a plurality of different productivity applications to encourage a user to learn more than one productivity application, even one that the user presently does not have stored on his computing device. In other words, a user may launch features of a productivity application version that are not locally available to the user in one embodiment. These features are not installed on a user's computing device. Rather, they may be installed as a “test” version as part of the challenge experience. The features are started with the challenge after the challenge is selected. A user may thus be able to play challenges for commands/features of productivity applications that the user did not have operating on their computing device at the start of the experience. In an alternative embodiment, challenges are launched from productivity applications currently available on their computing devices. When one moves from level to level of consolidated learning toot game play, animation may create a more enjoyable experience for the player. In one embodiment, the animation may comprise a hot air balloon rising followed by an invitation to begin play at the next level. The rising hot air balloon may even emit stars. A user input signifying CONTINUE to the next skill level, may cause a cartoon or other sequence to play landing on a consolidated game board for a next level of play.

In one embodiment, a user of a computing device obtains access to a consolidated game board user interface, for example, by actuating a selection from one of a menu, a toolbar, a ribbon or other user interface of the challenge director interface. The challenge director interface may store and display a skill level of play and an accumulated score. When actuated, the challenge director interface connects a user to or locally actuates a challenge director. The challenge director may be a program module which actuates a display of a consolidated learning tool game board for the skill level of play personal to a user.

In an embodiment, an overall theme such as time travel may be provided with a consolidated learning tool game board user interface that is then actuated for display by the challenge director at a user's computing device in place of a productivity application display screen. Thus, the consolidated game board may take a user away from the productivity application the user is currently utilizing and place them in an imaginary world. The learning tool game play of the consolidated game board may be controlled by the challenge director module which may be downloaded to a user's computing device or accessed from a network server.

One aspect of the embodiment is that a user (or player) may have an accompanying cartoon character such as a paper clip named “Clippy” during play of the consolidated learning game. Consolidated game boards for different skill levels may represent different imaginary worlds or sub-themes within the overall theme of time travel, such as THE 1960's, ANCIENT EGYPT or THE MIDDLE AGES. The general theme of time travel and sub-theme for a level such as THE MIDDLE AGES, for example, are exemplary only. In an alternative embodiment, for example, the overall theme may be space travel and the levels of play represented by THE MOON, MARS, THE MILKY WAY and the like. In accordance with the overall theme and sub-themes, an animation may be triggered during game play at a skill level. For example, in a game skill level representing THE FUTURE, there may be an animation of a flying saucer abducting a cow from earth. During game level animations may further comprise time movement from day to night, moving clouds, moving water and the like.

In a further embodiment, the consolidated game flow game board may offer entertaining animations during game play at a given milestone of point achievement or periodically during game play. One example of such an animation may be in ANCIENT EGYPT causing the game board to be illuminated by a moon at night and a sun by day so that, over time of learning tool game play, the user may see an imaginary world of ANCIENT EGYPT by day and by night. Similar animations during game play at a skill level in another imaginary world may comprise clouds moving, streams flowing and the like. During game play at one skill level, for example, for THE FUTURE, the abduction by the flying saucer may occur, for example, when a certain accumulated point score is reached or when the user arrives at the imaginary world of THE FUTURE.

In one embodiment, clickable, hoverable or otherwise selectable images, for example, may be provided, within the consolidated game board display of a sub-theme image representing a level of game play, such as a sphinx of the ANCIENT EGYPT sub-theme having further icons or symbols representing challenge selection, completion and bonus points. For example, an image of a Sphinx from the ANCIENT EGYPT sub-theme game board may display different icons, such as a checkmark and/or a star and/or a plus sign, within a given challenge. A checkmark may indicate successful selection and a star accomplishment of the challenge respectively. The plus sign may indicate bonus point awards.

In an embodiment of a consolidated game board and during game play, a banner may be displayed on the game board indicating the productivity application (or applications) that the challenge is associated with, identification of a command or feature of the productivity application learned, a fun phrase such as “Clippy breaks the Sphinx” indicating, for example, the success of the cartoon game character (or avatar) with respect to a particular challenge and an associated score and any bonus points achieved by winning the challenge.

These and other features of a system and method for consolidating game flow and, at the same time, providing fun animations for encouraging teaming a plurality of different productivity applications will become clear from the drawings and detailed description thereof which follows their brief description.

### BRIEF DESCRIPTION OF THE DRAWINGS

The features and advantages of the present invention will become more apparent from the detailed description set forth below when taken in conjunction with the drawings in which like reference numbers indicate identical or functionally similar elements.

FIG. 1 illustrates a computer architecture for a computer having a challenge director interface adapted for consolidated game flow for learning a plurality of different productivity applications.

FIG. 2 shows an exemplary process of a challenge director of FIG. 1 for providing a consolidated learning system game interface for consolidating learning a plurality of different productivity applications.

FIG. 3 provides a sample display screen portion, for example, of a ribbon interface of a computing device according to FIG. 1 for accessing a challenge director process according to FIG. 2 in which an animation is currently playing comprising a rotating circle attention getter and the words PLAY NOW!.

FIG. 4 provides an example of a consolidated learning tool game board actuated for display on the computing device of FIG. 1 showing an overall theme, a sub-theme, a present level of game play, a user score, a fun phrase, a plurality of icons and a banner portion for consolidating a user's learning a plurality of different productivity applications in accordance with the computer architecture of FIG. 1 and the exemplary learning process of a challenge director of FIG. 2.

FIG. 5 provide several examples of different consolidated game boards and respective different levels of play representing different sub-themes, for example, imaginary worlds, within an overall theme wherein FIG. 5A provides an exemplary consolidated game skill level 1 interface having a sub-theme of THE MIDDLE AGES of a time travel theme; FIG. 5B provides an exemplary consolidated game skill level 2 interface having a sub-theme of ANCIENT EGYPT; FIG. 5C provides an exemplary consolidated game skill level 3 interface having a sub-theme of THE 1960's; FIG. 5D provides an exemplary consolidated game skill level 4 interface having a sub-theme of ANCIENT GREECE; FIG. 5E provides an exemplary consolidated game skill level 5 interface having a sub-theme of THE RENAISSANCE; and FIG. 5F provides an exemplary consolidated game skill level 6 interface having a sub-theme of The Future.

FIG. 6 represent one example of a series of screen displays taken sequentially from a sequence of screen displays for moving from one skill level of play to a next higher skill level of play wherein FIG. 6A represents a screen shot showing a balloon rising animation sequence which may occur when an accumulated score for a skill level exceeds a predetermined score level; FIG. 6B provides a CONGRATULATIONS screen display wherein receiving a selection of CONTINUE causes replacement of the screen with an animation cartoon sequence leading to the next level of play and new imaginary world; and FIG. 6C provides a screen display taken from the animation cartoon sequence before arriving at the new imaginary world game board.

FIG. 7 provides an example of a second animation, namely, an animated announcement or real-time reward animation associated with learning tool game play for utilization of a tracked feature of a productivity application, namely underlining, at the challenge director interface of FIG. 3.

FIG. 8 provides an example of a further reward comprising an animation associated with learning tool game play or reaching a milestone of user utilization of a feature of a productivity application, namely underlining.

FIG. 9 provides an example of a screen shot taken from an animation that may occur during game play at a given skill level, in this case, an animation of an unidentified flying object abducting a cow in a traction beam in an imaginary world for THE FUTURE, skill level 6.

### DETAILED DESCRIPTION

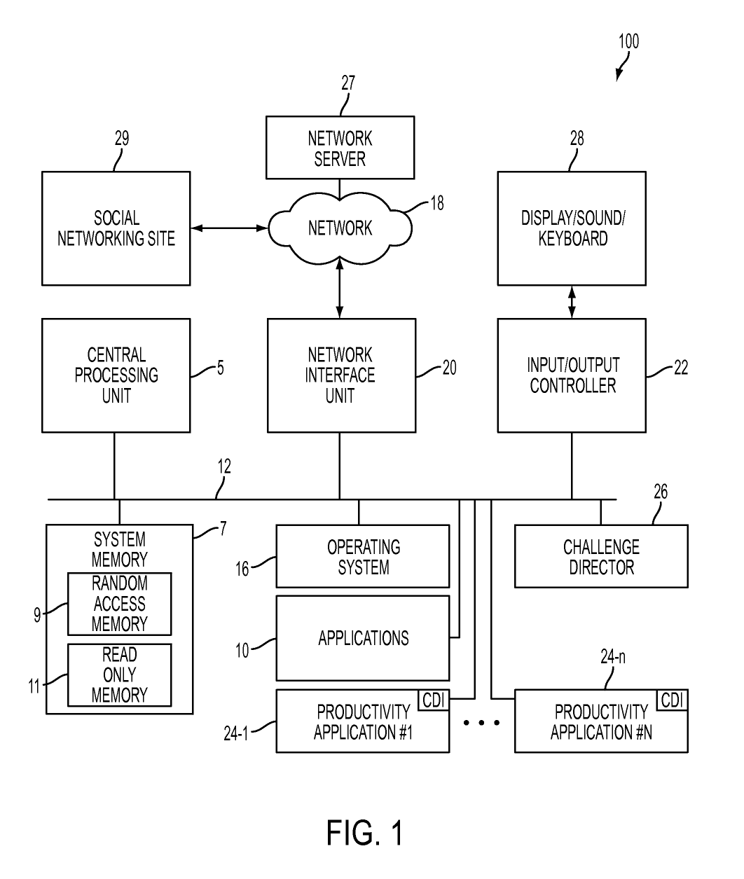

Referring now to the drawings, various embodiments will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. According to FIG. 1, a challenge director 26 may comprise a program module that may be implemented on a computing device 100 or provided remotely as accessible by computing device 100 via a network server 27. As will be further described herein, a challenge director 26 may be accessed via a challenge director interface of a productivity application 24-1 to 24-n which are intended to represent different productivity applications of a suite of such productivity applications. In an alternative embodiment, a challenge director interface may be actuated as a stand alone application on computing device 100.

Other computer system configurations may also be used, including multiprocessor systems, microprocessor-based or programmable consumer electronics, minicomputers, mainframe computers, and the like. Distributed computing environments may also be used where tasks are performed by remote processing devices that are linked through a communications network 18. In a distributed computing environment, program modules such as challenge director 26 may be located in both local and remote memory storage devices, for example, of computing device 100 or network server 27.

Referring now to FIG. 1, an illustrative computer architecture for a computing device 100 utilized in the various embodiments will be described. In various embodiments, computing device 100 or network server 27 may be configured as a desktop computer, a laptop computer, a personal digital assistant (PDA), another form of intelligent communication device, a tablet, a server, or other mobile computer, a commercially-available intelligent communications device, combination thereof or the like. Computing device 100, as may network server 27, may include a central processing unit 5 (“CPU”) specially programmed to permit play of a consolidated learning tool game for a plurality of productivity applications. The challenge director 26 of one of computing device 100 or network server 27 may be accessed via a productivity application 24 challenge director interface (CDI). A computing device 100 or server 27 may further comprise a system memory 7, including a random access memory 9 (“RAM”) and a read-only memory (“ROM”) 11, and a system bus 12 for coupling the memory to the CPU 5. The challenge director interface of a productivity application may appear on a ribbon, a toolbar, as a menu item or other user interface and so may comprise a portion of a productivity application display screen via display 28. In an alternative embodiment, a challenge director interface may be actuated as a stand alone application on computing device 100. The challenge director interface may be a program module configured to provide a display of skill level of play of a consolidated learning tool game and an associated accumulated score and store the accumulated score and skill level for a given user computing device 100 memory. A basic input/output system (BIOS) containing the basic routines that help to transfer information between elements within the computing device 100 or server 27, such as during startup, is stored in the ROM 11.

The computing device 100 further may include a mass storage device (not shown) for storing an operating system 16 such as the Microsoft Windows® operating system, different productivity application programs 24-1 through 24-n for, for example, word processing, spreadsheet preparation, drawing preparation, presentation preparation, collecting documents and other media together and the like, each productivity application having a challenge director interface (CDI) to the challenge director 26 or, according to an alternative embodiment, the challenge director interface being a stand alone application of computing device 100. The challenge director 26, as described above, may be accessed from a server and downloaded to computing device 100 of an individual user or be provided for access by computing device 100 from network server 27 where the server 27 is connected to computing device 100 via a network interface unit 20 and network 18. Challenge director 26 may be a program module that communicates with and controls a consolidated game interface or game board for play of challenges for learning a plurality of different productivity application commands, and coordinated use thereof, such as new features of resident versions of different productivity applications 24 on computing device 100 as will be described in greater detail below. In an alternative embodiment, challenge director 26 may launch a test version of a productivity application for playing a challenge associated with a given productivity application challenge, for example, from network server 27 or from another network server connected to network 18 where the test version is not presently installed on the computing device when the challenge is selected. Rather, as will be further described herein, in this embodiment, the test/trial version of the productivity application may be received at computing device 100 with the challenge but not installed. Also, challenge director 26 may also be launched from a network server 27 when called by the challenge director interface.

The mass storage device may be connected to the CPU 5 through a mass storage controller (not shown) connected to the bus 12. The mass storage device and its associated computer-readable media provide non-volatile storage for the computing device 100. Although the description of computer-readable media contained herein refers to a mass storage device, such as a hard disk or CD-ROM drive, the computer-readable media can be any available media that can be accessed by the computing device 100. Challenge director 26 may further be provided by means of such computer readable media.

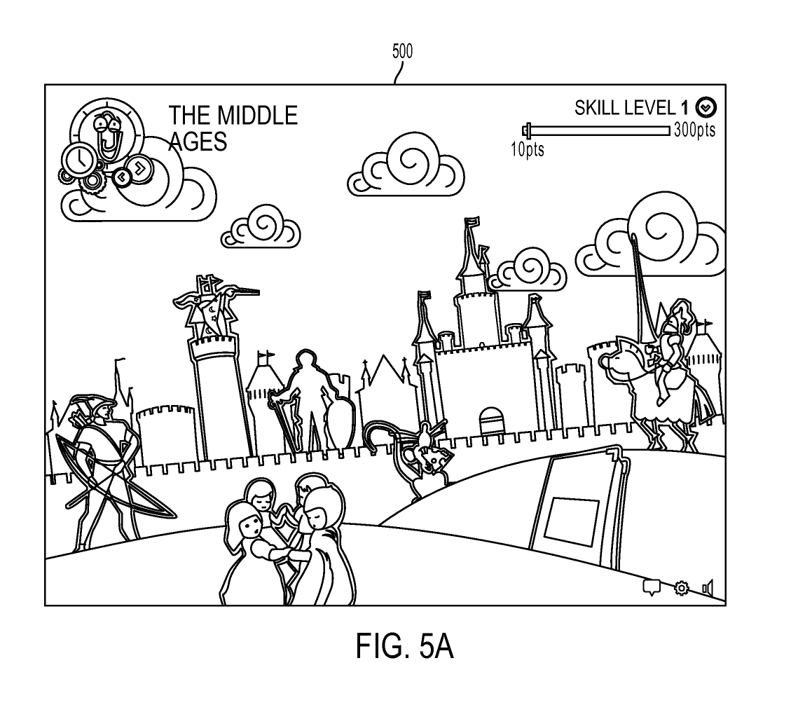

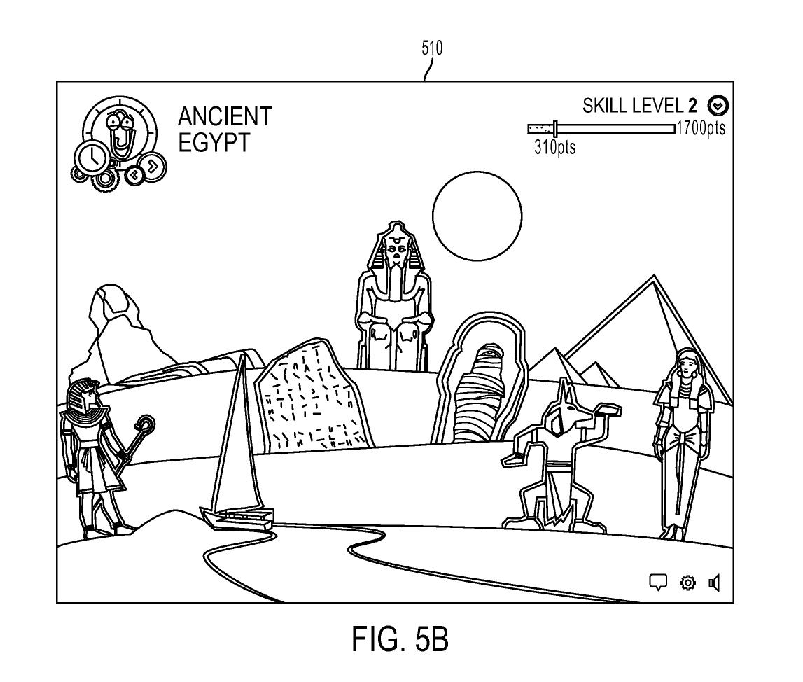

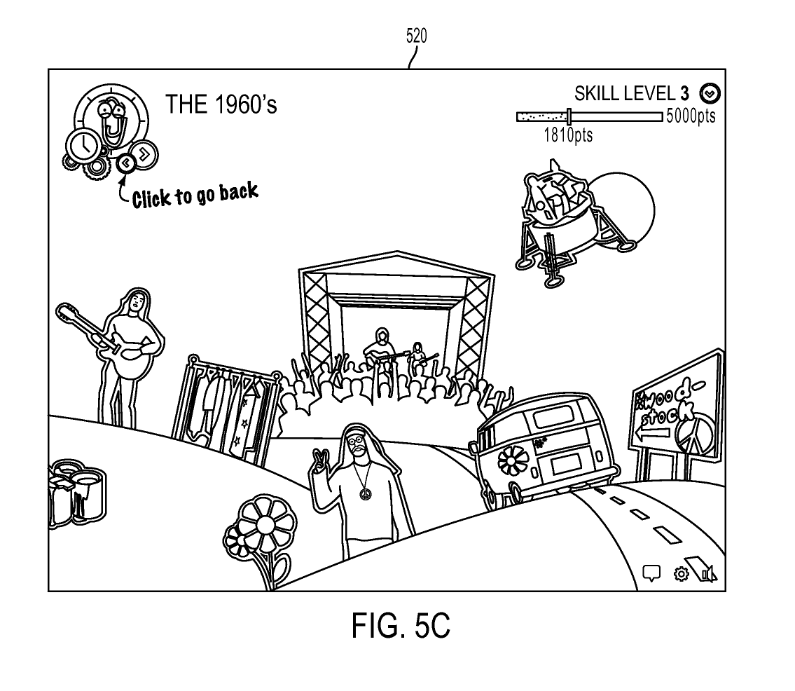

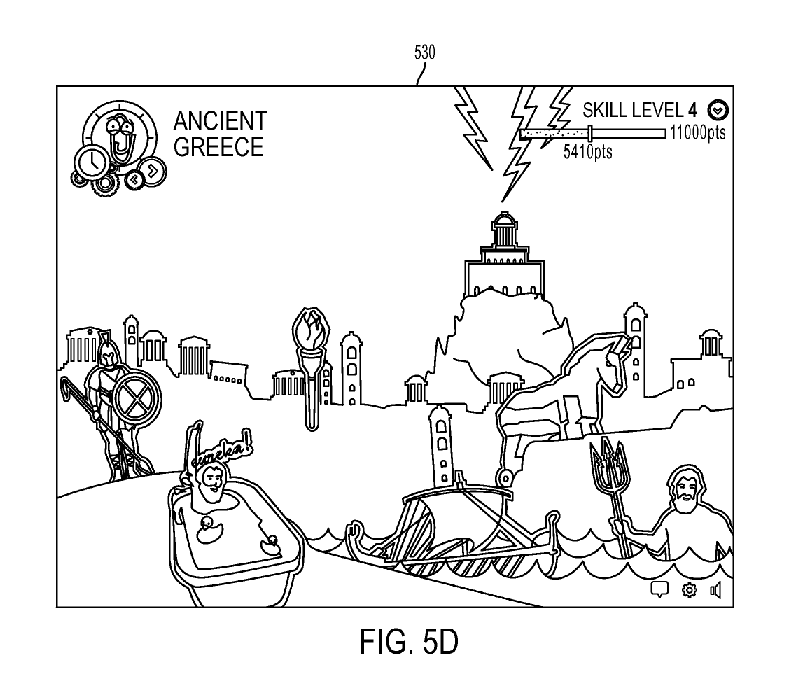

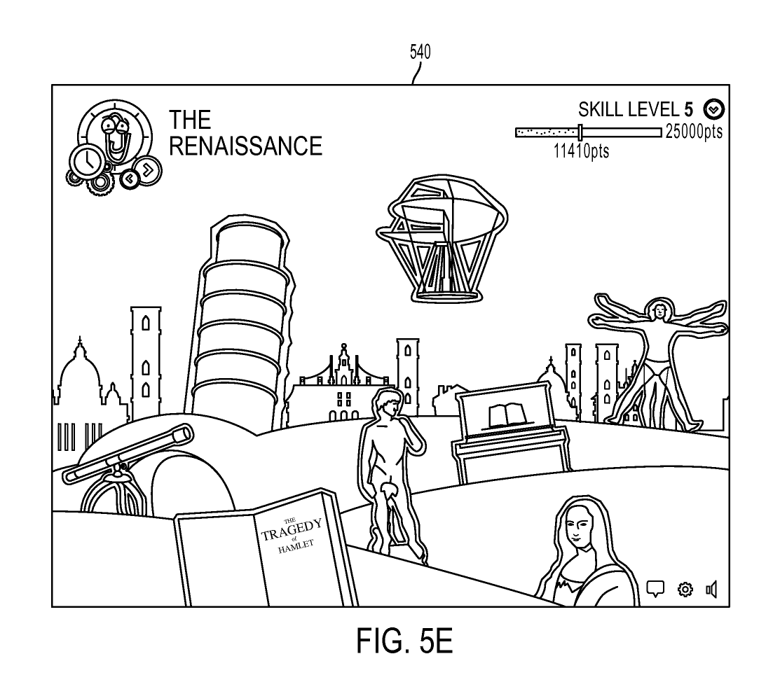

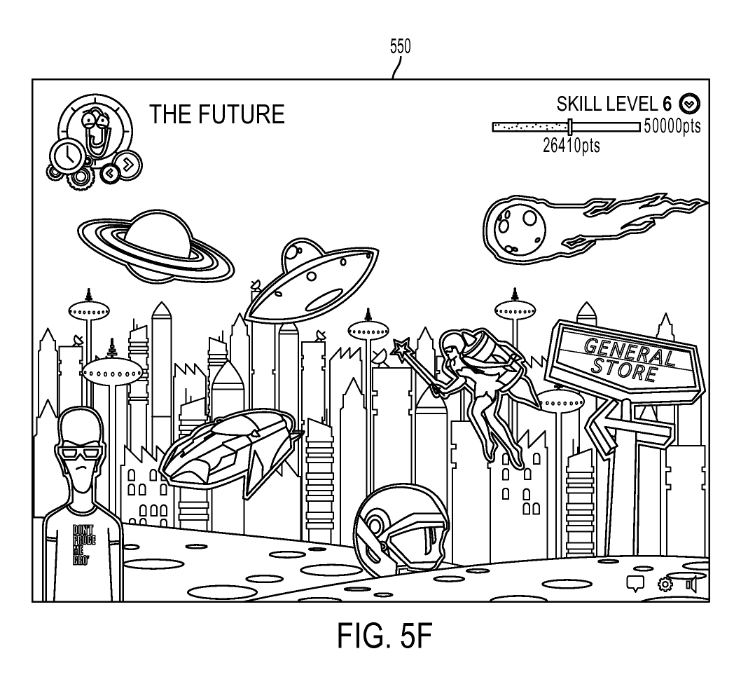

The term computer readable media as used herein may include computer storage media. Computer storage media may include volatile and nonvolatile, removable and non-removable media implemented in any method or technology for storage of information, such as computer readable instructions, data structures, program modules, or other data. System memory 7, removable storage and non-removable storage are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 100. Any such computer storage media may be part of device 100. Computing device 100 may also have input device(s) 28 such as a keyboard, a mouse, a pen, a sound input device, a joystick or equivalent, a touch input device, etc. Output device(s) 28 such as a display, speakers, a printer, etc. may also be included. A display of a consolidated game flow board of output device 28 and provided by challenge director 26 may conform to an overall theme for learning tool game play, such as time travel, as will be further described herein with reference to FIGS. 4 and 5. The aforementioned output devices are examples and others may be used, for example, an interactive touch screen tablet which may simultaneously provide input and an output display.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

According to various embodiments, computing device 100 operates in a networked environment using logical connections to remote computers or servers 27 through a network 18, such as the Internet. As briefly explained above, a challenge director 26 may be hosted on a server 27 and be accessed from computing device 100 via a challenge director interface of a productivity application 24. The computing device 100 may connect to the network cloud 18 and to network server 27 through a network interface unit 20 connected to a bus 12. The network connection may be wireless and/or wired. The network interface unit 20 may also be utilized to connect to other types of networks and remote computer systems.

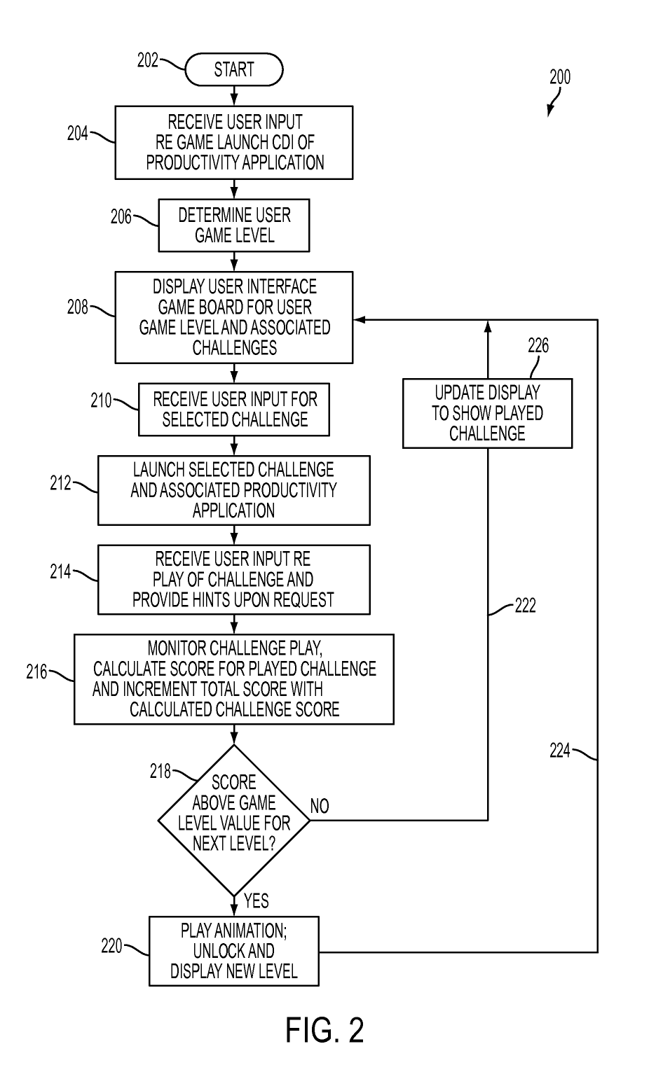

The computing device 100 may also include an input/output controller 22 for receiving and processing input from a number of other devices, including a keyboard, mouse, or electronic stylus (not shown in FIG. 1). Similarly, an input/output controller 22 may provide output to a display screen that includes a user interface such as a display screen which in one embodiment may display a challenge director interface (CDI) of a productivity application 24, or a consolidated game board per one of FIGS. 4 and 5, a printer, or other type of input/output device 28. User interface (UI) 28 is designed to provide a user with a visual way to interact with a productivity application 24 or program module thereof such as a challenge director interface. The CDI may interface with a challenge director 26 that incorporates consolidated game play elements for learning features of a productivity application. As will be described with reference to a process of consolidating game flow as depicted in FIG. 2, a user of computing device 100 may interact with other functionality of other different productivity applications 24 that may be included on computing device 100 via a game board of FIG. 4 or 5 for consolidating game flow. Challenge director 26 actuates a version of a productivity application 24 currently installed on the user's computing device 100. In one embodiment, challenges and associated test versions of productivity applications 24 may be remotely downloaded from a network server 27 and started together to play associated challenges.

As mentioned briefly above, a number of program modules and data files may be stored in a mass storage device (not shown) and a RAM 9 of the computing device 100, including an operating system 16 suitable for controlling the operation of a networked computer, such as the WINDOWS 7® operating system from MICROSOFT CORPORATION of Redmond, Wash. The mass storage device and RAM 9 of computing device 100 may also store one or more program modules, for example, a challenge director interface which may appear in a particular portion of a screen of a selected productivity application 24. The challenge director interface may be periodically refreshed at computing device 100 by downloading a new interface from network 18 and server 27 connected to the network cloud 18. In particular, the mass storage device and the RAM 9 of computing device 100 may store one or more different productivity application programs 24-1 to 24-n or modules thereof with each having a challenge director interface (CDI).

One of the productivity applications 24 may be one selected from a suite of such applications, i.e., one of the MICROSOFT OFFICE® programs. For example, a word processing productivity application 24 may comprise related features and menu, toolbar, ribbon or related user interface or control structure to a presentation productivity application or to a spreadsheet productivity application and so on. Through these control structures, a challenge director interface may be provided to challenge director 26. In one embodiment, a challenge director interface comprises a predetermined portion of a ribbon of a productivity application 24 display screen for ease of access or, in an alternative embodiment, may comprise a stand alone application.

Generally, productivity application 24 is one of a suite of productivity applications that a user may utilize in order to complete a task, such as authoring a document in a word-processing program, programming a feature, authoring a spreadsheet, and the like. Productivity application 24 may be an application such as a word-processing program, a presentation program, a spreadsheet program, a database program, a programming environment, and the like. Challenge director 26 may be configured to incorporate elements of learning tool game play into and among productivity applications 24 to assist in motivating users to learn how to use features of different productivity applications. One productivity application may share similar features or provide an encouragement to learn many related features of different productivity applications, for example, by outputting an integrated cumulative score for all productivity application challenges played via a challenge director 26 consolidated game board. For example, the elements of game play that may be incorporated into a consolidated learning game tool application may include items such as usage statistics, scores, levels, challenges, achievements, competition, and the like.

Challenge director 26, once accessed via challenge director interface (CDI), is a locally or remotely accessible program module that may be configured to track the usage of the features within and among the productivity applications by a user. Challenge director 26 may provide a user with feedback relating to the usage of features of productivity applications 24 as well as to provide recommendations on what features to learn next.

Moreover, even if a user may have an older version of a word processing productivity application stored on computing device 100, the user may temporarily obtain a newer test version of the word processing productivity application or a test version of a different productivity application 24 that may be launched by challenge director 26 and associated with game play of a challenge related to the newer version. The user may thus learn related features and commands or may be encouraged to acquire a different related productivity application or the latest version of a productivity application 24. For example, a user or player may be encouraged to obtain a drawing productivity application as they prepare a document requiring drawings using their word processing productivity application by being presented with a related challenge by challenge director 26.

Recommendations for challenges may be based on what features the user has already learned in a given productivity application by completing challenges or from measuring proficiency during their use of the productivity application, what features are related in other productivity applications and/or based on what features the user's peers are using in a social network 29. Moreover, in order to move from one level to a next, a learning tool game may require a predetermined level of proficiency in more than one productivity application 24 to advance to the next level.

Challenge director 26 may also be configured to link help content that is associated with a productivity application for a given challenge with the features/commands that are currently being used by the user in a challenge such that the help content for the feature that is currently being used is available to the user with a single selection. The help content may be considered hints to complete a challenge. Challenge director 26 may be configured to incorporate the use of a social networking site 29 such that a user's peers may be obtained to engage in active competition and to provide updates to the user and the user's peers as to accomplishments using one or more features of the productivity applications 24 learned and challenges played.

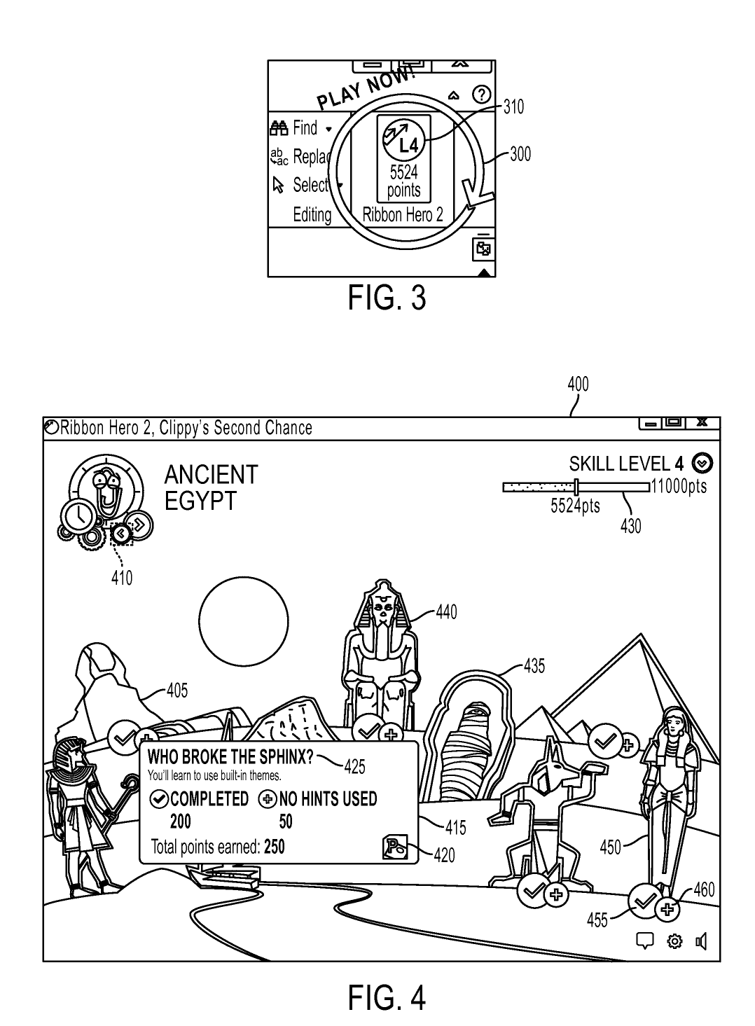

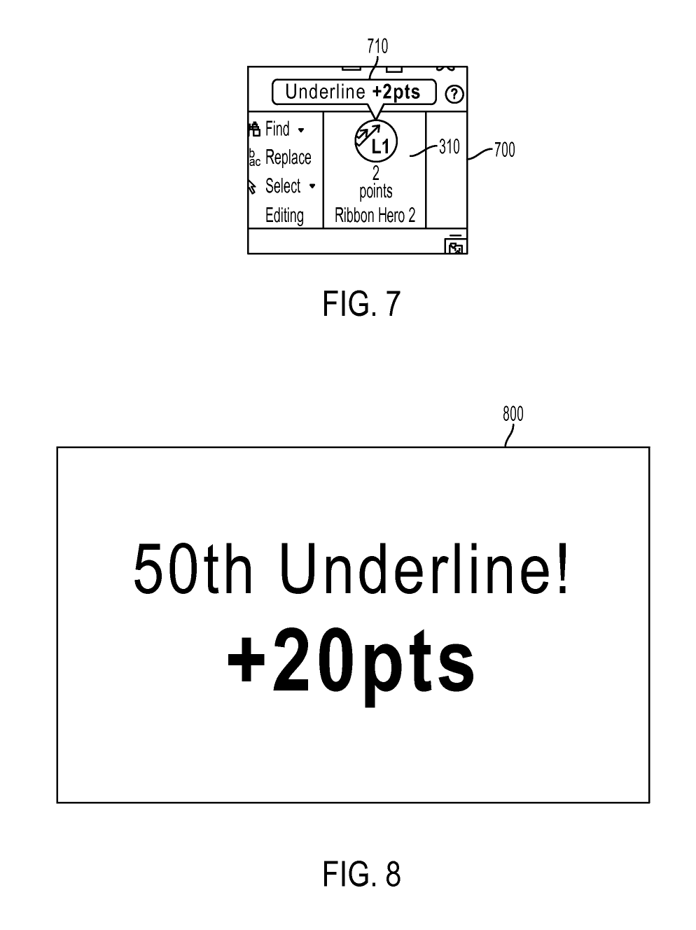

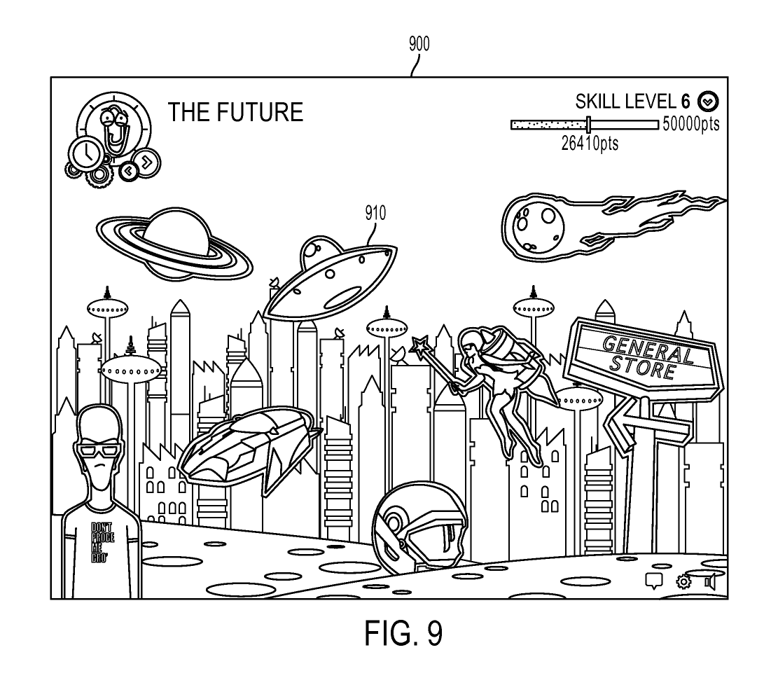

Challenge director 26 may provide animations as will be described with reference to FIGS. 3, 7, 8 and 9 controlling a challenge director interface, for example, to a productivity application as will be described further herein. In one animation, per FIG. 3, provided in the vicinity of the display screen portion for the challenge director interface of the productivity application, for example, a rotating circle and the words: Play Now! May be an attention getter to travel to an imaginary world of learning tool game play. FIGS. 7 and 8 represent animations that may reward a skill demonstrated in the productivity application, for example, a reward animation may be provided in the vicinity of the display screen portion for the challenge director interface of the productivity application, for example, to provide some score points for utilizing a learned feature or for achieving a milestone such as fifty usages where the animation may comprise a moving banner. FIG. 9 represents an animation, for example, of an abduction of a cow by a flying saucer which may be played on arrival at the imaginary world of THE FUTURE or when a certain score level is achieved.

According to an embodiment, a consolidated game board such as one depicted in one of FIG. 4, 5 or 9 may be provided that takes a user to an imaginary world and allows the user to see how they are performing both individually as well as how they are performing relative to other users of their peer group (not shown). For example, a group may be a work group, a set of designated friends, friends from one or more social networking sites 29, users who have a similar work title, users in the same profession, and the like. In this way, a user may compare their learning tool game scores, levels and learning experience to other similarly situated users. Scores and accomplishments may be delivered to other users automatically and/or manually. For example, a user's friends on a social networking site 29 may be notified under control of challenge director 26 when a user achieves a certain number of points and/or an accomplishment in one of the productivity applications or the suite of productivity applications 24 as a whole. A user's wall on the social networking site 29 may also be updated with messages indicating the user's progress in the productivity application 24 and/or the suite of productivity applications 24.

Challenge director 26 may allow a user to learn about features that may be useful to them by actuating versions of productivity applications 24 currently installed on computing device 100 to play challenges. The user of computing device 100 may not be aware of a given feature since the user may not be currently using the most current version of the productivity application 24 or a related feature of a related productivity application of potential interest (such as a drawing productivity application permitting the preparation of drawings for inclusion in a document being prepared using a word processing productivity application). As will be further described herein, if a feature or command to be learned by a user is not available locally at computing device 100, the challenge director 26, for example, from network server 27 may provide the user with temporary access to a test version of a productivity application 24 associated with an offered challenge so that the user may play the challenge for the new version.

Display 28 of computing device 100 may be configured to provide the user with a visual display of a challenge director interface located at a portion of a display screen of a productivity application 24 currently being utilized. When the challenge director interface is actuated, a consolidated challenge game board according to one of FIG. 4, 5 or 9 at a determined level of game play is presented to the user. The challenge director 26 recalls or retrieves from the challenge director interface the user of the productivity application, what level of game play the user has reached and so provides an appropriate game board for the determined level of learning tool game play and associated accumulated score.

Different computing devices 100 may be used by the same user when performing challenges and interacting with a productivity application 24. As a result, a certain user may accumulate points on one or more different computers with the same user name. A data store of challenge director 26 may be configured to provide challenge director 26 with the most current score information for a user such that points obtained across different computer systems by the user may be combined to create a single score that incorporates all of the points of the different computing systems for all the challenges played for many different productivity applications. This score information may be obtained in different ways. The accumulated score may be forwarded by challenge director 26 to a challenge director interface played for a computing device 100 currently utilized. For example, the globally stored score information may be obtained from challenge director 26 when a user logs onto a system. When the user togs onto the system, the most current score information may be obtained and used to update the globally stored score information with the locally stored information either at the computing device 100 or a network server 27. Upon logging onto the system, the system may determine that the points on the local system for a given user do not match the globally stored information and so retrieve the latest skill level and score originating from utilized computing devices 100 via challenge director 26.

According to one embodiment, a social network identifier may be used to uniquely identify the user within a consolidated game flow database and obtain score information for that user. The points stored locally on the computing device 100 may be compared to the globally obtained scores and a union of the points from all challenges played on all computing devices 100 may be used to update the score and level of play that the user has achieved.

Referring now to FIG. 2, there is shown an illustrative process 200 for a challenge director module 26 of computing device 100 or remote network server 27 of FIG. 1 employing game elements to motivate learning within and among different productivity applications 24.

FIG. 2 provides an illustrative process 200 for employing game elements to motivate learning features commands of a suite of productivity applications via a consolidated game flow board representing different imaginary worlds according to one of FIGS. 4, 5 and 9. When reading the discussion of the routines of process 200 presented in FIG. 2, it should be appreciated that the logical operations of various embodiments are implemented: (1) as a sequence of computer-implemented acts or program modules running on a computing system; and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start operation 202, the process 200 flows to operation 204, where the game director 26 receives user input re learning tool game launch from a challenge director interface (CDI) within a productivity application 24 that is currently utilized by a user. In an alternative embodiment, the CDI may be actuated as a stand alone application of computing device 100. As will be further explained with reference to animation FIG. 3 and, in one embodiment, productivity application 24 may be provided with a screen portion 300 within a ribbon, toolbar, dropdown menu or other user interface whereby a learning tool game, herein, Ribbon Hero 2 may be actuated. CDI may locally store skill level and accumulated score for Ribbon Hero 2 in computing device 100 that may be updated when challenge director 26 is accessed. A user may select Ribbon Hero 2 at any time by simply actuating the challenge director 26 by any appropriate selection process known in the art from the actuation portion of the screen, for example, one depicted in FIG. 3. Also, shown surrounding the screen portion is an animation which may be played to the user when the productivity application is first actuated inviting the user to not use the productivity application but rather to Play Now!

Moving to operation 206, challenge director 26 determines the learning tool game level and score for a particular user as explained in some detail above and may update FIG. 3 accordingly for the user. In accordance with one aspect and referring briefly to FIG. 3, a CDI of productivity application 24 may be animated and be an attention-getting device whereby, for example, the productivity application screen portion displays, for example, a rotating circle with a pointing arrow in color and encourages the user to “Play Now!” The animation may play on entry to a productivity application 24, periodically, or when a productivity application 24 is about to shut down. Other events may trigger an animation of the challenge director interface 300 of FIG. 3, A further example will be discussed with reference to FIG. 7. The screen portion need not be animated.

In accordance with operation 206, the screen portion 300 for the CDI 200 shown on the ribbon command interface to a word processing productivity application 24 may identify the skill level of learning tool game play reached 310 (in this case, level 4) and an accumulated score (in this case, 5524 points). The CDI 300, having identified the user of the productivity application, for example, a word processing application, may receive and display score, level and the like from challenge director 26 if these differ from those locally stored by CDI 300 on the presently utilized computing device 100.

Moving to operation 208, challenge director 26 replaces a display screen of a productivity application 24 with a consolidated game board display according to one of FIG. 4, one of FIG. 5 or FIG. 9, depending on the skill level of game play of the user. The consolidated game board display takes the user, for example, to an imaginary world and away from the productivity application 24. In the case of an overall theme of consolidated game play of time travel, a user is transported from a display of a productivity application 24 to an imaginary world. If a user is at level one of learning tool game play, and in keeping, for example, with an overall theme of time travel, a user may be transported to a game board 500 for THE MIDDLE AGES represented by FIG. 5A or other imaginary world represented by FIGS. 5B through 5F and FIG. 9. If a user is at level two of learning tool game play, and in keeping, for example, with an overall theme of time travel, a user may be transported to a game board 510 for ANCIENT EGYPT represented by FIG. 5B. If a user is at level three of learning tool game play, and in keeping, for example, with an overall theme of time travel, a user may be transported to a game board 520 for THE 1960's represented by FIG. 5C. If a user is at skill level four of learning tool game play, and in keeping, for example, with an overall theme of time travel, a user may be transported to a game board 530 for ANCIENT GREECE represented by FIG. 5D. If a user is at level five of learning tool game play, and in keeping, for example, with an overall theme of time travel, a user may be transported to a game board 540 for THE RENAISSANCE represented by FIG. 5E. If a user is at level six of learning tool game play, and in keeping, for example, with an overall theme of time travel, a user may be transported to a game board 550, 900 for THE FUTURE represented by FIG. 5F or FIG. 9. Of course, there may be fewer or more levels than are shown in FIG. 5 and FIG. 9 combined, i.e., six skill levels for a consolidated learning tool game. There may be a different overall theme than time travel such as space travel (instead of time travel) or other overall theme only limited by the imagination. There may be different score levels for reaching a next skill level of play from a current skill level. Following a space travel theme, for example, one may land on the moon, as a first skill level, then, Mars as a second skill level and so on as sub-themes and the number of skill levels and score levels required for reaching a next skill level may vary.

Moving to operation 210, the challenge director 26 receives user input for a selected challenge. In order to receive user input for a selected challenge, the challenge director 26 initially associates a screen image selected by a user by known input methods with a challenge of a particular productivity application. Referring to FIG. 4, there is shown a consolidated game board 400 for ANCIENT EGYPT. At the upper left of the screen, there may be displayed cartoon character, Clippy, in a time machine representation 410, which may be proximate to an ANCIENT EGYPT label for game board 400. A typical screen image of the consolidated game board display associated with a challenge may be a sphinx 405. (“Image” as used herein and in the claims shall mean an image, a drawing, a figure or other depiction of a selectable portion of a consolidated game board user interface.) An associated challenge may be learning to use built-in themes in a presentation productivity application announced in a banner 415 at position 425. Hovering over the sphinx 405 or otherwise using input/output controller 22, a challenge for the sphinx may be disclosed to the user. In the upper right of game board 400 may be found the skill level of the user at the time, skill level 4, and an indication of an accumulated point total 430 which may be in the form of a graph showing, for example, that 5524 points have been accumulated toward the total needed for the next level of 11,000 points.

Moving to operation 212, the challenge director 26 launches the selected challenge and associated version of productivity application 24 that is currently available on the user's computing device for, for example, the sphinx image. In one embodiment, the challenge relates to a version of productivity application 24 currently available and installed on computing device 100. In an alternative embodiment, a challenge and a test version of a productivity application not available at computing device 100 may be downloaded from a remote server 27 and started together. The test version may not be installed on computing device 100 when a challenge is selected; rather, the test productivity application may be started together with the challenge. In either embodiment, the display screen once again takes the form of a productivity application 24 associated with the selected challenge and appears as a portion of the consolidated game board screen 400 or replaces it in total. A work screen from the productivity application may be launched from local computing device 100. In this embodiment, a challenge director 26 will utilize versions of productivity applications and provide challenges for productivity applications stored and available on computing device 100. In an alternative embodiment, if the productivity application 24 associated with the selected challenge is not available locally at computing device 100, a test version of the unavailable productivity application 24 may be downloaded under control of challenge director 26 or may be made available from a network server 27 for remote use to play the challenge, also under control of the challenge director 26. (Either a presentation productivity application, for example, that may be launched locally or launched by downloading under control of challenge director 26, may be indicated at 420, for example, by its icon). A test version of the productivity application 24 may be temporarily made available at computing device 100 after a challenge for that productivity application version is selected. The features are not installed on a user's computing device 100. The test version is started with the challenge after the challenge is selected and is limited to actuation as part of the challenge experience. In an alternative embodiment, challenges are launched for versions of productivity applications currently available and installed on a user's computing device 100. The test version is started with the challenge after the challenge is selected and is limited to actuation as part of the challenge experience. In an alternative embodiment, challenges are launched for versions of productivity applications currently available and installed on a user's computing device 100. In an alternative embodiment, a user may skip a challenge related to a productivity application 24 not available on their computing device 100. An aspect of an embodiment wherein a missing version of a productivity application for play of a challenge may be downloaded under control of a challenge director 26 is that a user may thus be encouraged to learn or possibly obtain a new version of utilized productivity applications 24 that the user did not have operating on their computing device 100 at the start of the experience. The user may be encouraged to obtain a new version of a utilized productivity application that the user did not have operating on his computing device 100 at the start of the experience. As such, the learning tool game may encourage users to explore additional productivity applications or versions thereof beyond what the user already has installed at the start of the learning tool game.

Moving to operation 214, the challenge director 26 receives user input for the user's play of the challenge and provides and records usage of hints for challenge play. A user may complete a challenge without using any hints. On the other hand, a user may be encouraged to successfully complete a challenge using hints. It may be more important for a user to successfully learn a feature/command represented by a challenge for a productivity application 24 than for the user to try to complete the challenge unaided by any hints. For example, to complete the challenge, the user may be awarded 200 points while, using no hints, the user is awarded 50, substantially fewer, bonus points. Consequently, the number of points awarded for challenge completion may greatly exceed the number of bonus points awarded for using few or no hints. In one embodiment, if one uses a hint, the player is unable to obtain any bonus points. In an alternative embodiment, the number of bonus points may decrease with the use of more hints, but the points awarded for completion of the challenge may remain the same predetermined value, such as 200 points, regardless of the number of hints used. Once a user has completed a challenge displayed from a work screen of a productivity application 24, the user may be returned to a consolidated game board, for example, consolidated game board 400 of per FIG. 4.

Moving to operation 216, the challenge director 26 monitors challenge play, for example, the use of built-in themes in a presentation application associated with the sphinx. The challenge director 26 calculates a score for the played challenge and increments the total score at that level with a calculated score which may comprise a predetermined value for successful completion, e.g., 200 points and a second element for successful completion with as few hints as the user needs to complete the challenge, in this case 50 bonus points for using no hints displayed in banner 415, the total points earned being 250. As may be seen in challenge director interface FIG. 3, representing a button 310 for accessing challenge director 26, the score may be displayed in FIG. 3 and, in addition, upon return to the consolidated game board of FIG. 4, the score may be displayed in graphical form at 430. Note that the same score of 5524 points is displayed at button 310 of FIG. 3 and underneath score bar 430 of FIG. 4.

Referring further to FIG. 4, there are shown a number of images within an ANCIENT consolidated game board, one being a sphinx 405, another being a mummy 435, another being a statue of a pharaoh 440 and another being Cleopatra 450. Underneath the sphinx 405, the pharaoh 440 or Cleopatra 450, for example, are shown an icon or symbol such as a check mark 455 indicating that a user has completed a challenge associated with that image. A further icon or symbol such as plus sign 460 underneath an image may represent a value of bonus points for a challenge associated with an image whereby the user receives bonus points for using as few hints or help as possible to complete the challenge. In addition to the consolidated game board 400, commands normally provided external to the game board 400 such as minimize (−), shrink and close are shown at the upper right of the screen so that game play may be closed and computing device 100 may return to productivity application 24 or another underlying application currently running. On the other hand, a label may be provided at the upper left of the screen reading: Ribbon Hero 2, Clippy's Second Chance, identifying that the challenge director 26 for Ribbon Hero 2 is in control of the display.

A challenge associated with an image of Cleopatra 450 has both been previously selected and completed indicated by a symbol, for example, the checkmark 455. The plus sign 460 may indicate bonus points, A challenge associated with the sphinx 405 has just been played. Both a checkmark for having been selected and a plus sign indicating completion of the challenge with certain bonus points for hint usage (especially, non-usage) may be adjacent sphinx 405. There is a banner 415 for the just completed challenge. By way of example, the banner may read “WHO BROKE THE SPHINX, You'll learn to use built-in themes.” Further, in the banner 415, and, for example, associated with a checkmark for completion, one may receive 200 points. Bonus points indicated by the plus sign may be valued at 50 points when no hints are used. As the number of hints used increases, there may be fewer of no bonus points awarded. This user has earned 250 points or 200 points for completion plus 50 points for no hints used. Also in the banner 415 is an indication, here, an icon 420 for a Microsoft PowerPoint® presentation productivity application 24 to which the challenge was directed—a presentation command or feature of using built-in themes.

Referring again to FIG. 2 and moving to operation 218, there is a decision box shown whereby challenge director 26 determines whether the accumulated score at the game level exceeds a predetermined level for reaching the next level of play. Furthermore, there may be a requirement built into the consolidated game board, for example, FIG. 4, that different commands/features from more than one different productivity application be utilized before moving to the next level of play. If the accumulated game score is not above the score to reach the next skill level of game play, process 200 moves from decision box 218 to box 228. At operation 228, for example, the consolidated game board display 400 of FIG. 4 is updated to show that a challenge, represented by an image portion such as Cleopatra 450 and, most recently, the sphinx 405 has been played. Mummy 435 and its associated challenge appear to have not been played yet. Control of process 200 then returns to operation 208 where the updated consolidated game board for the user's skill level of play is displayed at display 28.

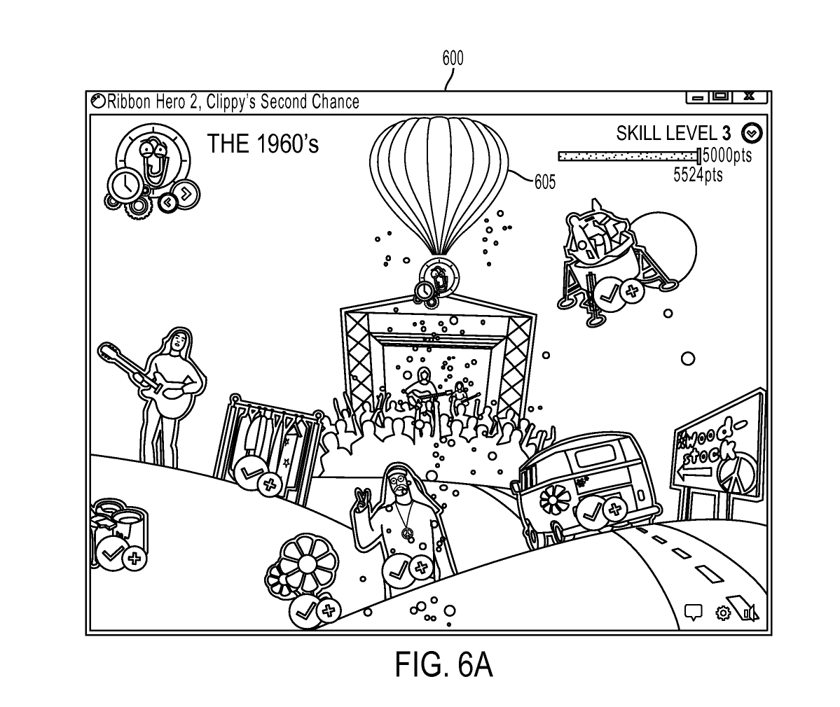

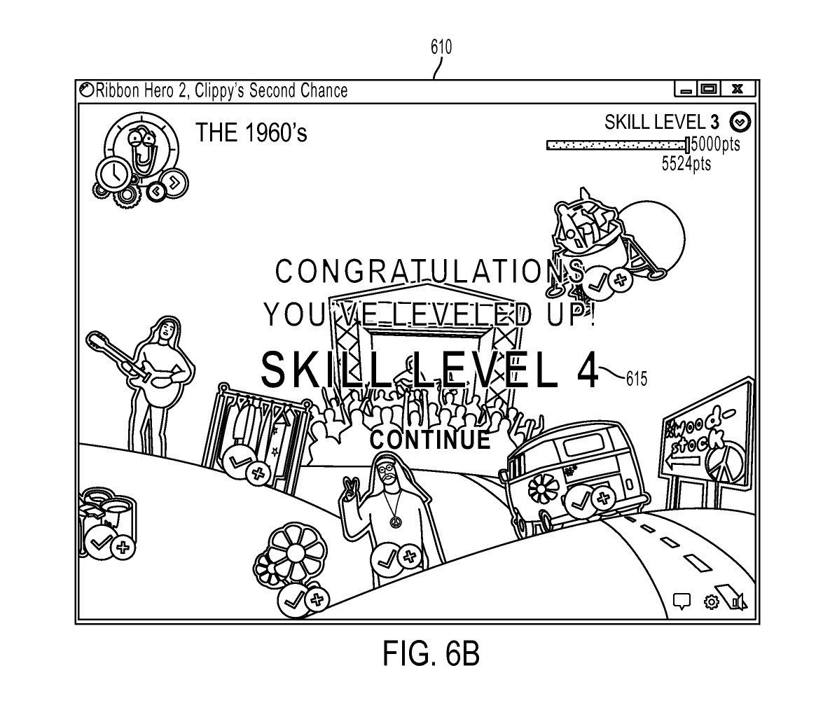

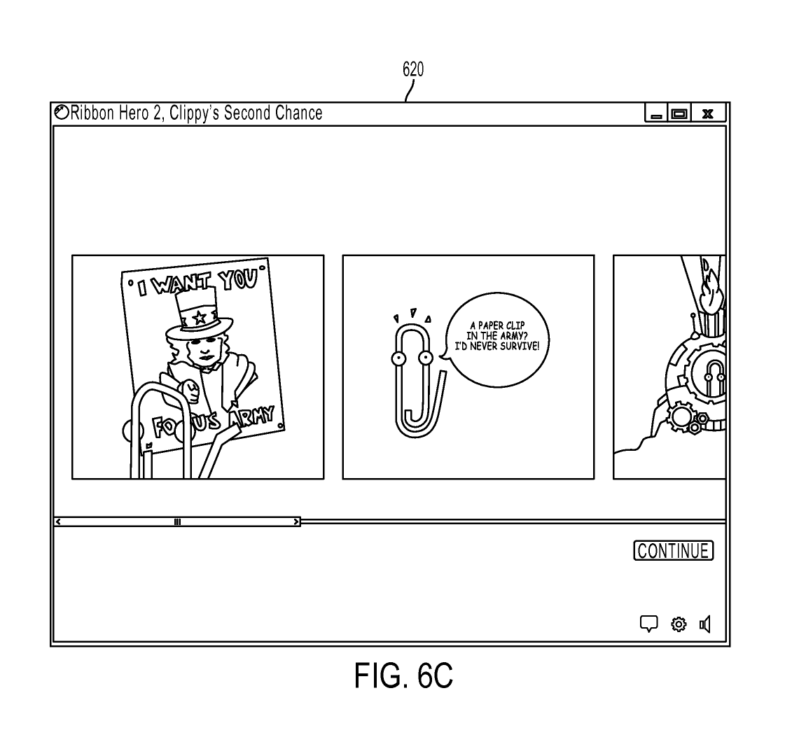

If at decision box 218, the game level score now exceeds a score necessary to move to the next skill level of game play, then, a new consolidated game board may be displayed for the next level. Referring briefly to FIG. 5A, the consolidated game board image 500 for THE MIDDLE AGES may give way to the consolidated game board screen 510 for ANCIENT EGYPT of FIG. 5B. If a score for ANCIENT EGYPT, FIG. 5B of 1700 points is exceeded, a game board. 520 shown in FIG. 5C with a sub-theme of THE 1960's for skill level 3 may be displayed requiring a higher score of 5000 points. If accumulated score total 5000 points is exceeded, then, FIG. 5D consolidated game board 530 for ANCIENT GREECE may be displayed and so on through FIG. 5E, game board 540 for THE RENAISSANCE and FIG. 5F for game board 550 and FIG. 9 game board 900 for THE FUTURE which may be displayed. Skill level 6 may represent the highest skill level of learning tool game play; however, any number of skill levels may be provided. In accordance with an aspect of the embodiment, an animation or other reward may be provided between levels of game play at operation 220. The animation and further details of operation 220 will be described herein with reference to FIGS. 6A-6C.

Referring briefly to FIG. 5A, there is shown a further imaginary world user interface for a first skill level of game play, for example, representing a sub-theme of THE MIDDLE AGES. The depicted user interface 500 for a consolidated game flow learning tool indicates at a given point in time that a user has achieved a score level of for example, 10 points. Since 300 points may be a predetermined level required to move from a first level to a second level, the user interface 500 indicates that the user has not completed the first level of learning tool game play. On the other hand, if the score of 300 points is exceeded by playing a challenge for more than one of the challenges represented by, for example, the depicted tower, the knight, the Canterbury Tales and the like image portions, then, play moves to the next level. The predetermined score level, for example, of 300 points may require the completion of features in one or more of a suite of productivity applications to reach the next level of play. In one embodiment, the predetermined score level may require completion of features in at least two different productivity applications, three productivity applications or all productivity applications of a suite to insure consolidated game flow and usage of all productivity applications of a suite by a user. For example, a predetermined score may be intentionally chosen such that the user may complete challenges in each of a word processing, presentation, drawing, and spreadsheet productivity application before moving to the next level of play. A challenge director 26 may control a download of a test version of a utilized productivity application from a network server 27. In this manner and as discussed with respect to operation 212, the user may receive and be encouraged to learn a new version of a utilized productivity application that the user did not have operating on their computing device 100 at the start of the experience. As such, the learning tool game may encourage users to explore additional productivity applications 24 or related features beyond what they already have installed at the start of using the learning tool game. The challenge director may download a test version of a related productivity application from network 18 or access to a server 27 thereof in order to launch a feature for a selected challenge associated with a different version or a different productivity application 24 not currently available on the user's computing device 100.

FIG. 5A, in a similar manner and at a similar position on the consolidated game board, may further show an exemplary user interface 500 for a first level of play within a theme of “time travel,” for example, indicated by a symbol such as a time clock shown at the upper left of the game board. The depicted sub-theme for the represented level of play, for example, skill level 1 (shown in a similar location as in FIG. 4) may be the “THE MIDDLE AGES” indicated, for example, also at the upper left of game board user interface 500. User interface 500 may indicate what challenges have been played and may use theme figures, images, drawings or other depictions to indicate further challenges not yet played.

Within user interface 500 as is shown in FIG. 4 but not in FIG. 5A, symbols such as checkmarks, stars (not shown) and plus signs may indicate what challenges have been selected, completed and bonus points awarded. FIGS. 5A-5F show clean game boards with no challenges played and bonus points earned for the images shown. On the other hand, FIG. 5B shows the accumulated score from THE MIDDLE AGES as a starting point for achieving a total score of 1700 points needed to reach FIG. 5C, “THE 1960's,” FIG. 5C shows the accumulated total of 1810 from ANCIENT EGYPT to reach THE 1960's and so on. Moving from THE 1960's to ANCIENT GREECE may require 5000 points. ANCIENT GREECE, FIG. 5D, shows that the user has an accumulated score of 5410 on arrival at ANCIENT GREECE. Similarly, THE RENAISSANCE FIG. 5E shows that the user has arrived at skill level 5 with 11410 points exceeding the 11000 points needed to leave skill level 4 and arrive at THE RENAISSANCE. Then, THE FUTURE FIG. 5F or FIG. 9 shows that the user has arrived at skill level 6 with 26410 points exceeding the 25000 points needed to leave skill level 5 and arrive in THE FUTURE.

Referring again to FIG. 5A, a castle tower may be an image, drawing, figure or the like to indicate a challenge for selection and play. An indication (not shown) of the productivity application utilized for the challenge may also be provided in a banner as in FIG. 4, A person shooting a bow and arrow may indicate a second challenge for selection and play in a different productivity application and so on.

Related features to challenges practiced may pertain to a first productivity application 24-1 or may be relate to more than one productivity application such as changing a font size or selecting a font for text in a word processing productivity application and a presentation productivity application. The feature may be specific to a particular application such as selecting an equation for calculating a particular cell in a spreadsheet productivity application and the like. Further challenges selected, played and won may be shown associated with sub-theme images of FIGS. 4, 5 and 9.

Referring again to FIG. 5A, with the accomplishment of a plurality of challenges including, for example, at least one challenge from more than one productivity application, a score level of 300 points may be indicated within user interface 500 as having been accomplished per operation 220 of FIG. 2. For example, a total score of 312 points just reached may be indicated at an upper right area of a game board in the graph area, showing that the user may advance to the next level.

As briefly explained above, when an indicated score for a level exceeds the required score for that skill level, then, a reward may follow, starting, for example, the unlocking of a video or a special animation sequence of a reward. Operation 220 of FIG. 2 will now be described in further detail with reference to FIGS. 6A-6C. The animation sequence may have components associated with mastering a skill level of play and introducing the next skill level of play. For example, referring to FIG. 6A, the mastering of a level of play may be indicated by an animation comprising a rising hot air balloon 605 carrying an animation character, such as Clippy, the paper clip. The rising hot air balloon 605 may emit stars as it rises. The screen display 600 for a given skill level, in this case level 3 for THE 1960's may be darkened but showing that a predetermined point score, in this case, of 5000 points has been exceeded and reached 5524 points. After the balloon animation sequence, and referring to FIG. 6B, a CONGRATULATIONS, YOU'VE LEVELED UP!, CONTINUE screen may be displayed providing the user with a choice at proceeding to the next level via clicking CONTINUE operation 220 or returning to the productivity application by closing the challenge director 26 clicking on the x at the upper right, if the user inputs CONTINUE, an animation sequence may be played, for example, per FIG. 6C showing a cartoon or other sequence or video or movie clip, for example, showing Clippy having to serve in the army, for example, a part of the overall theme of time travel from THE 1960's, when there was a draft, to arrive at, for example, ANCIENT GREECE, FIG. 5D. Clippy may thus arrive at a next level of play from a lower skill level to a higher skill level which may represent a different sub-theme to the overall theme of time travel. Other examples of overall theme and related sub-theme may come to mind only limited by the imagination. For example, an overall theme may be space travel. A first level of play may have a related sub-theme of space travel to the moon. A second level of play may have a related sub-theme of space travel to Mars. A third level of play may have a related sub-theme of space travel to another galaxy.

FIG. 7 provides an example of a reward that may comprise an animation and may be associated with learning tool game play where the teaming tool may have the name Ribbon Hero 2. In one embodiment, an animation may be provided as a feature of a productivity application is utilized and be located, along with an indicator of the learning tool game, in a menu, toolbar, ribbon or other user interface 700 of the productivity application at location 310 or of a stand alone CDI application. In a related embodiment, this indicator, upon the recognition of a certain feature usage of a productivity application may provide an animation sequence suggesting the user of the productivity application “Play now!” per FIG. 3. In so suggesting, that portion of the user interface may provide an animation sequence to get the user's attention to a suggestion to play an associated challenge. The challenge may be selected by clicking on the menu, toolbar or ribbon portion 310.

FIG. 7 also specifically depicts a situation where an animation may be provided at the time a user of a productivity application obtains points of a score for performing a particular feature or accomplishment of an event such as underlining a passage. When underlining is performed, for example, in a word processing or presentation productivity application, the user may be awarded 2 points. The display may read Underline +2 pts 710 indicating the user is awarded two points for an underline command use. The award of two points may be accompanied, for example, by an animation comprising a small localized fireworks display of the CSI user interface (not shown). Other attention getters that may not distract a user concentrated on, for example, finishing a document in a timely manner may come to mind besides a fireworks display such as a change in color, change in shape or change in size of challenge director interface portion 310 or component thereof, playing background sounds and the like.

FIG. 8 provides an example of a further reward that may comprise an animation and may be associated with learning tool game play occurring during use of a productivity application. A productivity application workspace user interface for the selected challenge may display a scrolling banner 800 that occupies a substantial portion of a productivity application screen and, thus, may be a more substantial award indicator than the localized indicator 710 of FIG. 7. The banner 800 may be animated and displayed when a feature of a productivity application is utilized and reaches a milestone of user utilization. Banner 800 may be located anywhere in the challenge director interface or work screen area of a productivity application (or of a learning tool game), for example, in a menu, toolbar, ribbon or other user interface of the productivity application or in the work screen display, for example, when a document is being prepared in a word processing productivity application. As a banner 800, the banner may serve as a reward. 800 and may animate back to the Ribbon Hero button 310 (FIG. 3 or FIG. 7.) In an alternative button, banner 800 may scroll across a vertical portion of the workspace interface from one side to another, for example, from up to down, left to right or the like or diagonally or otherwise within the workspace interface such as in an oval shape. Again, the use of a milestone banner and associated score award or other milestone animation is only limited by the imagination.

Referring now to FIG. 9, there is shown an example of an animation that may be provided during game play, for example, on arrival in THE FUTURE, skill level 6 consolidated game board 900. In particular, and by way of example, a flying saucer may abduct a cow animation 910. The animation may occur on arrival in the future, when a predetermined accumulated score of 26000 points or other value is exceeded or may occur periodically during game play at the skill level of the depicted imaginary world. In ANCIENT EGYPT, for example, as time passes and play continues, the day represented by the sun may give way to the moon at night and so each rise and set. Other animations during learning tool game play are only limited by the imagination, for example, clouds moving across the sky or water flowing in a river.

Thus, there has been shown and described a number of embodiments of animation in a consolidated learning tool game flow for a plurality of productivity applications where the animations may be played within the productivity application or within an imaginary world of an interactive consolidated game board. The above specification, examples and data provide a complete description of the manufacture and use of the composition of the invention. Because many embodiments of the invention can be made without departing from the spirit and scope of the invention, the invention resides in the claims hereinafter appended.

What is claimed is:

1. A method for providing an animated interface within a productivity application for accessing an interactive consolidated game board, the method executing on a processor of a computer, comprising:
displaying a challenge director interface within an interactive display of a productivity application of a plurality of different productivity applications in the vicinity of one of a menu, a toolbar and a ribbon of one of the productivity application and a stand alone challenge director interface application;
displaying an animation proximate to the portion of the challenge director interface display, the animation configured to attract attention to play of a challenge related to one of the plurality of different productivity applications; and
receiving first user input causing replacement of the productivity application interactive display with a display of an interactive consolidated game board display.

2. The method of claim 1, wherein the animation comprises a rotating circle having a pointed arrow.

3. The method of claim 2, wherein the animation further comprises the words: Play Now.

4. A method for providing an animated user interface within a productivity application for rewarding use of a feature, the method executing on a processor of a computer, comprising:
displaying a challenge director interface within an interactive display of a productivity application of a plurality of different productivity applications in the vicinity of one of a menu, a toolbar and a ribbon of one of the productivity application and a stand alone challenge director interface application; and
displaying an animation proximate to the portion of the user interface display for rewarding the utilization of a productivity application feature, the animation adapted to announce the award of a predetermined score for the utilization of the tracked feature.

5. The method of claim 4, wherein the animation comprises a moving banner portion for displaying an accomplishment of a milestone related to use of the feature of the productivity application and identifying a score value of the accomplishment of the milestone.

6. The method of claim 5, wherein the banner portion is adapted to one of animate back to the challenge director interface within the productivity application, scroll from one side of a productivity workspace interface to another, or scroll diagonally across the workspace interface or in a predetermined pattern of the workspace interface of the productivity application.

7. The method of claim 4, wherein the animation comprises a rotating circle having a pointed arrow and the words: Play Now.

8. A computer program product having computer-executable instructions for providing an animated interface within a productivity application for accessing an interactive consolidated game board, the instructions executing on a processor of a computer, comprising:
displaying a challenge director interface within an interactive display of a productivity application of a plurality of different productivity applications in the vicinity of one of a menu, a toolbar and a ribbon of one of the productivity application and a stand alone challenge director interface application;
displaying an animation proximate to the portion of the challenge director interface display, the animation configured to attract attention to play of a challenge related to one of the plurality of different productivity applications; and
receiving first user input causing replacement of the productivity application interactive display with display of an interactive consolidated game board display.

9. The computer program product of claim 8, wherein the animation comprises a game score portion for one of displaying a score value for one of the accomplishment of a feature of the productivity application and of the accomplishment of a milestone of utilization of the feature.

10. The computer program product of claim 9, wherein the animation comprises a moving banner screen portion of the productivity application for announcing the accomplishment of the milestone.

11. The computer program product of claim 9, wherein the animation comprises a rotating circle having a pointed arrow and words encouraging play of a challenge.

12. The computer program product of claim 9, wherein the productivity application is a word processing application.

13. A computer-implemented method of providing animation within an interactive consolidated game board for a plurality of different productivity applications comprising:
displaying an imaginary world game board for presenting images for a plurality of challenges representing commands of the different productivity applications, the game board comprising different images, whereby an animation associated with one of the images comprises an animation sequence displayed upon arrival at the imaginary world game board, upon reaching a predetermined accumulated score of a productivity application learning game or continuously during game play.

14. The computer-implemented method of claim 13 wherein the animation comprises a movement of the image within the imaginary world.

15. The method of claim 14, the animation comprising:
the movement of an image continuously during game play.

16. The method of claim 14, the animation comprising:
the movement of an image upon reaching a predetermined accumulated score value.

17. The method of claim 14, the animation comprising:
the movement of an image occurring upon arrival at the imaginary world game board.

18. A computer-implemented method of providing animation within an interactive consolidated game board for a plurality of different productivity applications comprising:
displaying a first imaginary world game board for presenting images for a plurality of challenges for a plurality of different productivity applications at a skill level of play;
displaying a first animation when an accumulated score total for learning tool game play exceeds a value for continuing to a next skill level of play;
displaying an interactive screen for receiving one of an input to close the first imaginary world game board and an input to continue to a next level of play;
responsive to an input representing to continue to the next level of play, displaying a second animation culminating in arrival at a second imaginary world game board for the next level of play.

19. The computer-implemented method of claim 18 wherein the first animation comprises a rising hot air balloon.

20. The computer-implemented method of claim 18, wherein the second animation comprises a cartoon character playing a character of an animation sequence.
